(19) United States
(12) Patent Application Publication
(10) Pub. No.: US 2007/0249773 A1
(43) Pub. Date: Oct. 25, 2007

(54) Polymeric Materials, Which Contain Inorganic Solids, and Methods for the Production Thereof

(76) Inventors: Bernhard Becker, Krefeld (DE); Jurgen Kastner, Bochum (DE); Franz Meyers, Charlotte, NC (US); Ralf Schellen, Moers (DE); Heiner Schulte, Soest (DE); Michael Wedler, Duisburg (DE)

Correspondence Address: FULBRIGHT & JAWORSKI, LLP, 666 FIFTH AVE, NEW YORK, NY, 10103-3198, US

(21) Appl. No.: 11/629,954

(22) PCT Filed: Jun. 28, 2005
(86) PCT No.: PCT/EP05/06947

§ 371 Date: Apr. 25, 2007

(30) Foreign Application Priority Data
Jun. 29, 2004 (DE) 10 2004 031 283.4

(51) Int. Cl. D06M 11/00; C08K 9/02; C08K 9/04

(52) U.S. Cl. 524/492; 524/497

(57) ABSTRACT

A polymeric material contains particulate TiO₂ and at least one other particulate inorganic substance that has a lower crystal hardness than TiO₂ in the anatase phase. The polymeric material can exist in the form of synthetic fibers or in the form of films or shaped parts.

The invention relates to polymer materials, especially synthetic fibres, containing inorganic solids, and to a process for their production.

Synthetic fibres are polymer materials. Synthetic fibres with high TiO₂ contents are known particularly as full-dull fibres, which contain up to 3 wt. % of TiO₂ (titanium dioxide).

High TiO₂ contents in synthetic fibres result in a particularly pronounced matting effect that is perceivable both visually and from the handling of the textile. This formulation of synthetic fibres is often desired in order to give the synthetic fibres a highly cotton-like appearance. Moreover, textile sheets produced from full-dull fibres formulated in this way have a particularly high opacity to UV radiation.

Full-dull fibres have a number of disadvantages. Thus clearly pronounced abrasion phenomena occur during the processing of full-dull fibres. These abrasion phenomena can be observed particularly when the fibres make contact with the structural components of the processing machines (such as thread guides, winding rollers, texturing disks, needles, etc.). Such abrasion phenomena occur to a much lesser extent e.g. in semi-dull fibres whose TiO₂ contents are approx. 5 times lower.

The TiO₂ content can lead to disadvantages in semi-dull systems as well. All the conventional titanium dioxides used as matting agents absorb UV radiation as a result of their semiconductor property, which, via processes in the titanium dioxide crystal, ultimately leads to free radical formation at the titanium dioxide crystal/polymer interface. In principle this can result in unwanted partial degradation reactions with associated changes in the colour of the polymer (“yellowing”).

It is known from DD 273 843 to lower the TiO₂ content of a high polymer and, for example, to add BaSO₄, the BaSO₄ content of the BaSO₄/TiO₂ matting agent combination being greater than 80% and the TiO₂ content being smaller than 20%.

The object of the invention is to overcome the disadvantages of the state of the art and to provide TiO₂-containing polymer materials which have the desired properties conventionally conferred by high TiO₂ contents, and in which at the same time abrasion phenomena occur to a markedly reduced extent. In particular, synthetic fibres should be provided in which abrasion phenomena occur to a markedly reduced extent compared with known full-dull fibres.

The object is achieved by TiO₂-containing materials in which part of the TiO₂ content is replaced by particulate inorganic substances having a lower crystal hardness than anatase.

Surprisingly, it has been found that the characteristic optical and haptic properties are not achieved exclusively by a high content of TiO₂ as filler, which acts inter alia as a matting agent. The desired effects can in fact be achieved with lower proportions of particulate TiO₂, the reduced amount of TiO₂ being compensated by other particulate inorganic substances. These inorganic particles which can be used according to the invention are preferably of a similar size to the TiO₂ used. As a rule the light-scattering capability of the particulate inorganic substances selected according to the invention is not as significant as that of TiO₂ and their lower crystal hardness results in a markedly lower abrasiveness of the polymer material. Surprisingly, despite the reduced amount of TiO₂, the desired material properties, such as full-dull optics and matt feel, are extensively or completely preserved by the high solids content that gives the surface structure.

Surprisingly, the partial replacement, provided by the invention, of the titanium dioxide by the particulate inorganic substances selected according to the invention is advantageous for semi-dull systems as well. As already explained above, all the conventional titanium dioxides used as pigments or (as in the present invention) as matting agents absorb UV radiation as a result of their semiconductor property, which, via processes in the titanium dioxide crystal, ultimately leads to free radical formation at the titanium dioxide crystal/polymer interface. In principle this can result in unwanted partial degradation reactions with associated changes in the colour of the polymer (“yellowing”). By contrast, the particulate inorganic substances selected according to the invention do not exhibit this property at all. Lowering of the absolute content of TiO₂ as filler and compensation by the particulate inorganic substances selected according to the invention, particularly preferably the BaSO₄ selected according to the invention, in order ultimately to achieve the desired degree of matting thus reduces the potential for the said degradation reactions, compared with the polymer dulled exclusively with TiO₂.

The polymer material is preferably selected from polyester (such as polyethylene terephthalate (PET), polytrimethylene terephthalate (PTT), polylactide (PLA)), polyamide (such as PA-6 or PA-6,6), polyolefin (such as polyethylene (PE) or polypropylene (PP)), polyacrylonitrile (PAN), viscose (CV) and cellulose acetate (CA).

The form of the polymer material according to the invention is not restricted to one particular embodiment. Preferably, the polymer material according to the invention takes the form of synthetic fibres (such as filaments, staple fibres or flocks). The polymer material can also take the form of films or mouldings.

According to the invention the following can preferably be used as particulate inorganic substances: BaSO₄ (untreated or coated), ZnS, carbonates (e.g. chalk or dolomite), phosphates, silicon dioxides or silicates (such as talcum, kaolin, mica).

The solids content of the additive mixtures according to the invention (sum of TiO₂ and particulate inorganic substance selected according to the invention) in the polymer material ranges preferably from 0.1 to 20 wt. % and particularly preferably from 0.1 to 10 wt. %. When the field of application is synthetic fibres, the solids content ranges from 0.1 to 5 wt. % and preferably from 0.15 to 0.5 wt. % or from 0.5 to 3 wt. %. When the field of application is polymer film, the solids content ranges from 0.1 to 20 wt. %, preferably from 0.1 to 8 wt. % and very particularly preferably from 0.4 to 5 wt. %.

In principle the proportion of particulate inorganic substance selected according to the invention in the additive according to the invention can be up to about 80 wt. %. This ensures that, even with high filler contents, a proportion of about 20 wt. % of the material with a high scattering capability, i.e. the TiO₂, in the additive according to the invention is still sufficiently high. If the proportion of particulate inorganic substance selected according to the invention were more than 80 wt. %, the light-scattering content would become so low that the desired matting would no longer be achievable. The weight ratio of TiO₂ to particulate inorganic substance selected according to the invention in the additive mixtures according to the invention is preferably in the range from 20 to 95 wt. % for the TiO₂ and 5 to 80 wt. % for the particulate inorganic substance selected according to the invention, e.g. 50 wt. % of TiO₂ and 50 wt. % of particulate inorganic substance selected according to the invention, or 33 wt. % and 67 wt. % respectively, or 25 wt. % and 75 wt. % respectively.

The polymer materials according to the invention can be produced in a manner known per se whereby the hitherto pure particulate TiO₂ pigment is replaced by the additive according to the invention, consisting of TiO₂ and the particulate inorganic “substitute” selected according to the invention. The additive according to the invention, or the TiO₂ pigment and the inorganic “substitute”, can be introduced in known manner, before, during or after the polymerization reaction. A further possibility is to introduce the additive according to the invention or the individual components, i.e. TiO₂ and the inorganic “substitute”, into the starting compounds of the polymer material.

The additive or the individual components are preferably introduced into the polymer production process dispersed in a suspension. If the substances would not chemically withstand the polymerization process (e.g. ZnS in PET) or the polymer process does not allow addition during the polymerization (e.g. PE or PP), it is expedient to add the substances to the polymer stream as a so-called masterbatch or as a preparation that is easy to distribute in the melt (e.g. a mixture of inorganic substances in a carrier).

The polymer material according to the invention is used e.g. in the manufacture of textile sheets, for example for clothing textiles or textiles for use in the home. Another use is e.g. the manufacture of polymer films and sheets (for example for packaging or printing applications) from the polymer material according to the invention.

The Examples which follow are intended to illustrate the invention in greater detail without implying a limitation:

### EXAMPLE 1

### Preparation of the Additive Used in the Polycondensation

The preparation of the additive used (full-dull additive) is based on the technology, adequately described in the technical literature, for the preparation of titanium dioxide in the anatase modification by the sulfate process. The process steps of digestion, purification, hydrolysis to metatitanic acid and calcination of the metatitanic acid to titanium dioxide are carried out in conventional manner. The calcination was followed by the homogeneous distribution in the titanium dioxide of another inorganic substance having a much lower crystal hardness than anatase. This was done by dispersing 15 kg of calcined titanium dioxide in 60 kg of water. Barium sulfate was then precipitated directly in this suspension: 130.6 kg of aqueous barium sulfide solution (10 wt. % of BaS, corresponding to 13.1 kg of BaS) and 112 kg of aqueous sodium sulfate solution (10 wt. % of Na₂SO₄, corresponding to 11.2 kg of Na₂SO₄ and hence to a 2% excess of sulfate ions to ensure complete precipitation of the barium ions) were introduced in parallel from storage containers over a period of 4 hours, by means of flow inducers, into 60 kg of the titanium dioxide suspension (20 wt. % of TiO₂, corresponding to 12 kg of TiO₂). The reaction mixture was stirred throughout and then heated at approx. 70° C. for a further 3 hours and kept at this temperature for 3 hours. The suspension was then passed through a suction filter while still warm and the filter cake was washed with 200 l of deionized water and then dried in a drying cabinet. The dried solid was coarsely precomminuted and finally micronized in an impact mill. Due to losses in the processing steps, approx. 22 kg of additive, consisting of 33% of TiO₂ and 67% of BaSO₄, remained.

15 kg of this inorganic additive were intimately dispersed in 15 kg of monoethylene glycol (MEG) by grinding in a mechanically agitated ball mill. The suspension obtained was diluted to a solids content of 20 wt. % with more monoethylene glycol.

### EXAMPLE 2

### Preparation of Polyester Granules with a High Content of Full-Dull Additive as Filler

Polyester granules with a high content of full-dull additive as filler were prepared in known manner as described below. 6.8 kg of polyester precondensate (BHET from Aldrich) and 1.1 kg of monoethylene glycol were placed in a batch reactor (of approximate volume 50 l) and melted. After approx. 1 hour a paste consisting of 16.7 kg of terephthalic acid and 5.4 kg of monoethylene glycol was fed into the container. The esterification took place in known manner over a period of roughly 160 minutes, the temperature of the reaction mixture reaching approx. 280° C. The end point of the esterification reaction was defined by the end of water elimination.

2.78 kg of the full-dull additive suspension prepared in Example 1 (containing 20 wt. % of solids in monoethylene glycol) were then added to the reaction mixture. The system was stirred for a further 20 minutes at 250 to 270° C. to complete the mixing, 5.86 g of Sb₂O₃ in the form of a 10% suspension in monoethylene glycol were added as polycondensation catalyst (corresponding to 300 ppm, based on terephthalic acid), stirring was continued for 10 minutes and the mixture was then transferred to the polycondensation reactor.

The polycondensation was subsequently carried out in known manner over a period of approx. 100 minutes, the pressure being lowered to a final value of 2 mbar and the temperature of the reaction mixture being 285 to 290° C. As the criterion for the end of the reaction (reaching of an intrinsic viscosity of 0.63 dl/g, determined on a solution of 0.5 g of PET granules in 100 ml of a phenol/1,2-dichlorophenol mixture in a weight ratio of 3/2), the increase in torque on the stirrer was monitored until it reached the value corresponding to this viscosity. This was followed by extrusion of the melt out of the reactor under a positive pressure of nitrogen, cooling and granulation of the polymer strand.

The resulting granules contained 2 wt. % of the full-dull additive (determined by measurement of the ashing residue) and, with the intrinsic viscosity reaching 0.62 to 0.65 dl/g, were suitable for spinning into textile filaments.

### EXAMPLE 3

### Production of Full-Dull Filaments of Reduced Abrasion

The full-dull filaments according to the invention were produced in a simple and known manner by the melt spinning process.

Testing of Dyeability

The systems provided by the invention were tested for their dyeability. This is a process conventionally used by those skilled in the art to assess the quality of a full-dull and/or semi-dull system.

It was used to compare synthetic fibres which had been produced with 0.33% of TiO₂ and with the same concentration of an additive provided by the invention, respectively:
preparation of polyester granules using a suspension of a matting agent mixture according to the invention (TiO₂/BaSO₄, 1/1) in a 35 l batch autoclave in known manner (formulation, process parameters, reaction course, etc.)
spinning of these granules into a standard partially orientated yarn (called POY, 67 f 13) at a speed of 3200 m/min
then drawing of the POY into fully drawn yarn, FDY (drawing ratio=1:1.6); POY and FDY were characterized by determination of the titre and measurement of the force elongation behaviour (elongation and ultimate tensile strength)
production therefrom of knitted hoses on a circular knitting machine
dyeing of the knitted hoses with one commercially available red disperse dye and one commercially available blue disperse dye with different diffusion characteristics (red: rapid; blue: slow); dyeing performed at two temperatures (100 and 130° C.)
calorimetric analysis of the dyed knitted hoses: K/S values, L*a*b* values

Surprisingly, no significant differences in the values were found, even though this would not have been surprising in view of the difference in the matting agents used.

1-18. (canceled)

19. A polymer material comprising a polymer, particulate TiO₂ and at least one particulate inorganic substance having a lower crystal hardness than TiO₂ in the anatase modification.

20. The oolymer material according to claim 19, wherein the particulate inorganic substance is at least one of BaSO₄, ZnS, a carbonate, a phosphate, silicon dioxide and a silicate.

21. The polymer material according to claim 19, wherein the particulate inorganic substance is at least one of coated BaSO₄, chalk, dolomite, talcum, kaolin or mica.

22. The polymer material according to claim 19, wherein the content of TiO₂ and particulate inorganic substance in the polymer material ranges from 0.1 to 20 wt. %.

23. The polymer material according to claim 19, wherein the content of TiO₂ and particulate inorganic substance in the polymer material ranges from 0.1 to 5 wt. %.

24. The polymer material according to claim 19, wherein the content of TiO₂ and particulate inorganic substance in the polymer material ranges from 0.15 to 0.5 wt. %.

25. The polymer material according to claim 19, wherein the content of TiO₂ and particulate inorganic substance in the polymer material ranges from 0.5 to 3 wt. %.

26. The polymer material according to claim 19, wherein the content of TiO₂ and particulate inorganic substance in the polymer material ranges from 0.1 to 8 wt. %.

27. The polymer material according to claim 19, wherein the proportion of particulate inorganic substance in the additive consisting of TiO₂ and particulate inorganic substance is up to 80 wt. %.

28. The polymer material according to claim 19, wherein the weight ratio of TiO₂ to particulate inorganic substance based on the total weight of TiO₂ and particulate inorganic substance ranges from 20 to 95 wt. % for the TiO₂ and 5 to 80 wt. % for the particulate inorganic substance.

29. The polymer material according to claim 19, wherein the weight ratio of TiO₂ to particulate inorganic substance based on the total weight of the TiO₂ and the particulate inorganic substance is 50 wt. % of TiO₂ and 50 wt. % of particulate inorganic substance.

30. The polymer material according to claim 19, wherein the weight ratio of TiO₂ to particulate inorganic substance in the additive consisting of TiO₂ and particulate inorganic substance is 33 wt. % of TiO₂ and 67 wt. % of particulate inorganic substance.

31. The polymer material according to claim 19, wherein the weight ratio of TiO₂ to particulate inorganic substance in the additive consisting of TiO₂ and particulate inorganic substance is 25 wt. % of TiO₂ and 75 wt. % of particulate inorganic substance.

32. The polymer material according to claim 19, wherein the polymer is a polyester, polytrimethylene terephthalate, a polylactide, a polyamide, a poly-olefin, a polyacrylonitrile, viscose or cellulose acetate.

33. A polymer material according to claim 19, in the form of synthetic a fiber.

34. A polymer material according to claim 19 in the form of a film or a molding.

35. A process for the production of a polymer material according to claim 19, comprising introducing an additive comprising the TiO₂ and the particulate inorganic substance having a lower hardness than anatase, or the TiO₂ and the inorganic substance having a lower hardness than anatase, taken individually, into the polymer material before, during or after polymerization of the polymer.

36. A process for the production of a polymer material according to claim 19, comprising introducing an additive comprising the TiO₂ and the particulate inorganic substance having a lower hardness than anatase, or the TiO₂ and the inorganic substance having a lower hardness than anatase, taken individually, into the polymer.
